(19) United States
(12) Patent Application Publication
(10) Pub. No.: US 2022/0066531 A1
(43) Pub. Date: Mar. 3, 2022

(54) DOCKING STATION FOR POWER MANAGEMENT

(71) Applicant: REALTEK SEMICONDUCTOR CORP., Hsinchu (TW)

(72) Inventors: Zhen-Ting Huang, Hsinchu (TW); Er-Zih Wong, Hsinchu (TW); Shih-Chiang Chu, Hsinchu (TW); Chun-Hao Lin, Hsinchu (TW)

(73) Assignee: REALTEK SEMICONDUCTOR CORP., Hsinchu (TW)

(21) Appl. No.: 17/403,572

(22) Filed: Aug. 16, 2021

Related U.S. Application Data
(60) Provisional application No. 63/070,955, filed on Aug. 27, 2020.

(30) Foreign Application Priority Data
Jan. 15, 2021 (TW) 110101744

(51) Int. Cl. G06F 1/3234; H04L 12/12; G06F 13/42; G06F 1/16

(52) U.S. Cl. CPC G06F 1/3234; H04L 12/12; G06F 2213/0042; G06F 1/1632; G06F 13/4282

(57) ABSTRACT

A docking station for power management includes an integrated circuit, a first signal input/output (I/O) port, a network interface controller, and a first controller. The first signal I/O port is connected to a host controller of a host. When the host enters a sleep mode or a standby mode, the network interface controller is disconnected, or there is no network packet transmission, the integrated circuit cuts off a signal connection between the integrated circuit and the first signal I/O port, so that the host controller enters a deepest sleep state. When the network interface controller receives a wake-on-LAN signal, the network interface controller informs the first controller through a function pin, and the first controller wakes up the host controller through the first signal I/O port. The network interface controller controls, in response to the wake-on-LAN signal, the integrated circuit to re-establish the signal connection.

### CROSS-REFERENCES TO RELATED APPLICATIONS

This application claims the benefit of U.S. provisional application Ser. No. 63/070,955, filed on Aug. 27, 2020 and claims the priority of Patent Application No. 110101744 filed in Taiwan, R.O.C. on Jan. 15, 2021. The entirety of the above-mentioned patent applications are hereby incorporated by references herein and made a part of the specification.

### BACKGROUND

### Technical Field

The application relates to a docking station, and in particular, to a docking station for power management.

### Related Art

A standard docking station can provide a host computer (such as a notebook computer) with a plurality of expandable ports to install expansion devices such as a screen, a mouse, a keyboard, a network interface card, and the like. The docking station also has a power adapter electrically connected to a mains supply to supply power to the host computer and the expansion devices. In order to maintain lower power consumption, it is necessary to allow the host controller of the host computer to enter a deepest sleep state when idle, which is referred to as a D3 cold state below. A prerequisite for the host controller of the host computer to enter the D3 cold state is that all expansion devices connected to a downstream port can enter the D3 cold state. If one of the expansion devices cannot enter the D3 cold state, the entire host controller cannot enter the D3 cold state, increasing power consumption. Generally, the expansion device on the docking station that cannot enter the D3 cold state is usually a USB network interface card (NIC) that provides a wired network. In order to keep receiving wake-on-LAN (WOL) signal, the USB network interface card can only enter a D2 low-battery state but cannot enter the D3 cold state.

### SUMMARY

In view of the above, the application provides a docking station for power management adapted to be electrically connected to a host. The host includes a host controller. The docking station includes an integrated circuit, a first signal input/output (I/O) port, a network interface controller, and a first controller. The first signal I/O port is electrically connected to the integrated circuit and provides a connection to the host controller, so that a signal is transmitted between the host controller and the integrated circuit through the first signal I/O port. The network interface controller is electrically connected to the integrated circuit, configured to provide a connection to an external network, and has at least one function pin. The first controller is electrically connected to the function pin and the first signal I/O port. The first controller establishes a transmission channel with the host through the first signal I/O port. When the host initiates a sleep mode or a standby mode, the network interface controller is disconnected, or there is no network packet transmission, the integrated circuit cuts off a signal connection between the integrated circuit and the first signal I/O port, so that the host controller enters a deepest sleep state. When the network interface controller receives a wake-on-LAN signal from the external network, the network interface controller informs the first controller through the function pin. The first controller generates a sideband signal, and transmits the sideband signal to the host controller through the transmission channel to wake up the host controller, and the network interface controller controls, in response to the wake-on-LAN signal, the integrated circuit to re-establish the signal connection with the first signal I/O port.

According to some embodiments, when the host is inserted into the first signal I/O port, the integrated circuit is configured with and stores a related wake configuration for use by the host controller. When the network interface controller detects a disconnection of the host, the integrated circuit removes the wake configuration.

According to some embodiments, when the host controller is first woken up, the host controller transmits a restore signal to the first controller through the transmission channel, the first controller informs the network interface controller through the function pin, and the network interface controller controls, in response to the restore signal, the integrated circuit to re-establish the signal connection with the first signal I/O port.

According to some embodiments, the function pin further includes a wake pin and a restore pin to enable the network interface controller to inform the first controller through the wake pin, and enable the first controller to inform the network interface controller through the restore pin.

According to some embodiments, the first signal I/O port is a USB connector or a thunderbolt connector.

According to some embodiments, the host further includes a second controller electrically connected to the host controller, and the transmission channel is established by using the second controller, the first signal I/O port, and the first controller.

According to some embodiments, when the first signal I/O port is the USB connector, the first controller and the second controller each are a power delivery controller.

According to some embodiments, the above integrated circuit is integrated in the network interface controller.

Based on the above, in order to meet increasing requirements for power consumption and performance of tablet computers and notebook computers, the docking station is also correspondingly required to have lower power consumption. The docking station provided in the application allows the host controller of the host to enter the deepest sleep state (a D3 cold state) and also supports the wake-on-LAN function, thereby minimizing power consumption to achieve maximum power saving.

### BRIEF DESCRIPTION OF THE DRAWINGS

FIG. 1 is a schematic block diagram of a docking station according to an embodiment of the application.

FIG. 2 is a schematic block diagram of a docking station with a signal connection cut off according to an embodiment of the application.

FIG. 3 is a brief schematic block diagram of a logic circuit in an integrated circuit according to an embodiment of the application.

FIG. 4 is a schematic block diagram of a docking station according to another embodiment of the application.

FIG. 5 is a schematic block diagram of a docking station according to another embodiment of the application.

FIG. 6 is a schematic block diagram of a docking station with a signal connection cut off according to another embodiment of the application.

FIG. 7 is a schematic block diagram of a docking station according to still another embodiment of the application.

### DETAILED DESCRIPTION

The docking station provided in the application is adapted to be electrically connected to a host controller of a host, and the host controller provides a connection to a plurality of expansion devices through the docking station, so that all expansion devices connected to the docking station can enter a D3 cold state, thereby allowing the host controller to enter a D3 cold state which is a most power-saving state.

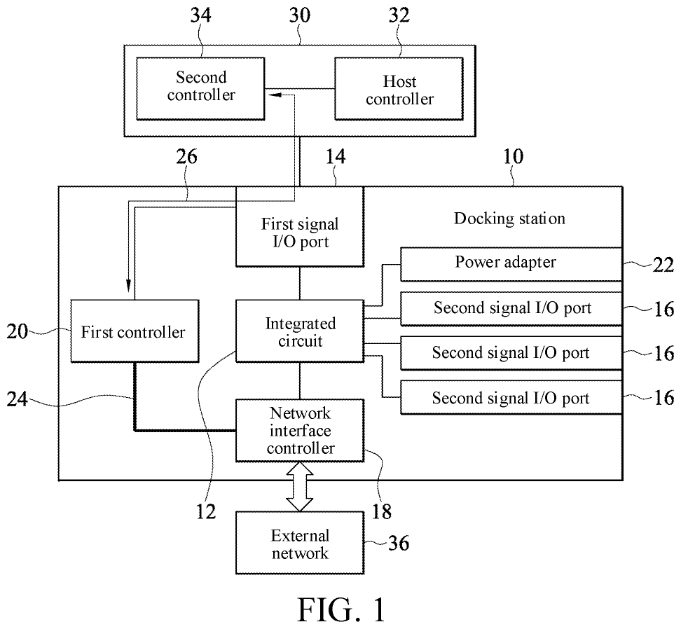

FIG. 1 is a schematic block diagram of a docking station according to an embodiment of the application. Referring to FIG. 1, a docking station 10 for power management is adapted to be electrically connected to a host 30. The docking station 10 includes an integrated circuit 12, a first signal I/O port 14, a plurality of second signal I/O ports 16, a network interface controller 18, and a first controller 20. In this embodiment, for example, three second signal I/O ports 16 are provided, but the application is not limited thereto. In an embodiment, the docking station 10 further includes a power adapter 22 which is electrically connected to the integrated circuit 12 and connected to an external mains supply to supply power to the integrated circuit 12 and all internal elements as well as the host 30 or the second signal I/O ports 16.

As shown in FIG. 1, the host 30 further includes a host controller 32 and a second controller 34, and the host controller 32 is electrically connected to the second controller 34. The first signal I/O port 14 is electrically connected to the integrated circuit 12 and provides a connection to the host controller 32 of the host 30, so that a signal is transmitted between the host controller 32 and the integrated circuit 12 through the first signal I/O port 14. The second signal I/O ports 16 are electrically connected to the integrated circuit 12 for connecting to a plurality of expansion devices. The network interface controller 18 is electrically connected to the integrated circuit 12, configured to provide a connection to an external network 36, and has at least one function pin 24. The first controller 20 is electrically connected to the function pin 24 and the first signal I/O port 14. The first controller 20 establishes a signal connection with the second controller 34 of the host 30 through the first signal I/O port 14, thereby establishing a transmission channel 26 by using the first controller 20, the first signal I/O port 14, and the second controller 34. In order to enable the host controller 32 to enter the deepest sleep state and maintain the wake-on-LAN support function of the docking station 10, a sideband signal is required. The sideband signal is responsible for transmission of a wake-on-LAN signal received by the network interface controller 18, and the first controller 20 is responsible for waking up the host controller 32 of the host 30.

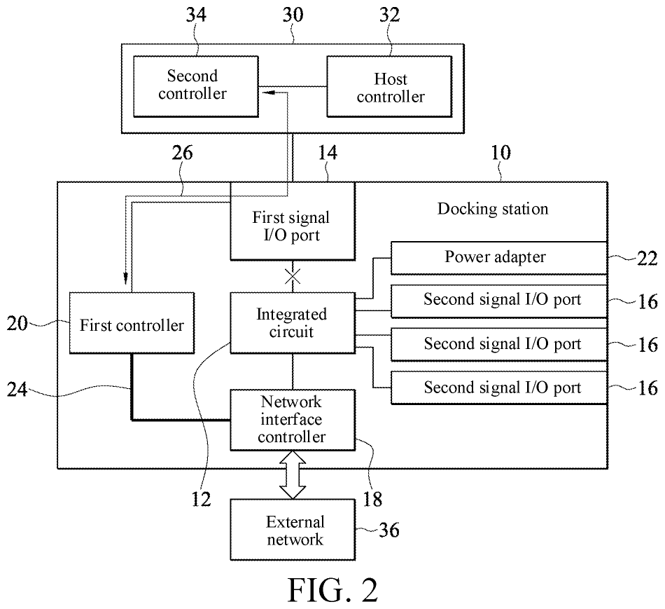

Referring to FIG. 1 and FIG. 2 together, when the host 30 initiates a sleep mode or a standby mode, the network interface controller 18 is disconnected, or there is no network packet transmission, the integrated circuit 12 cuts off a signal connection between the integrated circuit 12 and the first signal I/O port 14, so that the host controller 32 of the host 30 enters a deepest sleep state, that is, a D3 cold state. When the network interface controller 18 receives a wake-on-LAN signal from the external network 36, the network interface controller 18 informs the first controller 20 through the function pin 24, and the first controller 20 generates a sideband signal, and transmits the sideband signal to the host controller 32 through the transmission channel 26 to wake up the host controller 32. In addition, the network interface controller 18 controls, in response to the wake-on-LAN signal, the integrated circuit 12 to re-establish the signal connection with the first signal I/O port 14.

In an embodiment, the host 30 may be a notebook computer, a tablet computer, a personal computer, or the like, but the application is not limited thereto.

In an embodiment, the first signal I/O port 14 is a USB connector or a thunderbolt connector.

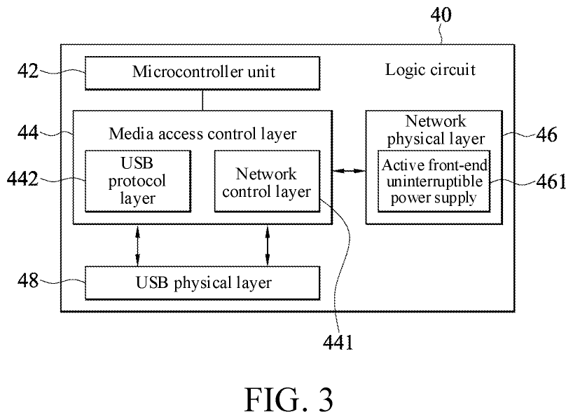

In an embodiment, when the first signal I/O port 14 is a USB connector, the host controller 32 is a USB host controller, and the first controller 20 and the second controller 34 each are a power delivery controller (PD controller). Therefore, the transmission channel 26 established by using the first controller 20, the first signal I/O port 14, and the second controller 34 is different from a general signal transmission channel, which can still maintain a low-power-consumption signal transmission function even in the sleep mode (including the D3 cold state) or the standby mode. Moreover, the signal connection between the integrated circuit 12 and the first signal I/O port 14 is re-established, that is generally called USB enumeration. Referring to FIG. 3, a logic circuit 40 in the integrated circuit 12 substantially includes a microcontroller unit (MCU) 42, a media access control (MAC) layer 44, a network physical layer 46, and a USB physical layer 48. The MAC layer 44 includes a network control layer 441 and a USB protocol layer 442. An active front-end uninterruptible power supply (afe-ups) 461 is provided in the network physical layer 46 for detecting insertion of a network connector. As shown in FIG. 1 to FIG. 3, the microcontroller unit 42 determines whether the host 30 (the host controller 32) has initiated the sleep mode or the standby mode, whether the network interface controller 18 is disconnected, or whether there is network packet transmission. When the host 30 enters the sleep mode or standby mode, the network interface controller 18 is disconnected, or there is no network packet transmission, the microcontroller unit 42 cuts off power supply to the USB physical layer 48 to cut off the signal connection between the integrated circuit 12 and the first signal I/O port 14, so that the host 30 determines that the first signal I/O port 14 is connected to no expansion device as a result of failing to recognize the network interface controller 18, thereby controlling the entire host controller 32 and the docking station 10 as well as the expansion devices connected to the docking station to enter the D3 cold state to minimize power consumption. When the network interface controller 18 receives a wake-on-LAN signal from the external network 36, the network interface controller 18 informs the first controller 20 through the function pin 24, and the first controller 20 generates a sideband signal, and transmits the sideband signal to the host controller 32 through the transmission channel 26 to wake up the host controller 32. In this case, the network interface controller 18 drives the integrated circuit 12 in response to the wake-on-LAN signal, so that the microcontroller unit 42 restores power supply to the USB physical layer 48 accordingly, and completes a standard plug-in of a new USB device (USB enumeration), to re-establish the signal connection between the integrated circuit 12 and the first signal I/O port 14.

In an embodiment, the second signal I/O port 16 may be any combination of a standard display port connector, a high definition multimedia interface (HDMI) connector, a video graphics array (VGA) connector, an audio output connector, or at least one USB connector. The standard display port connector is a standardized digital display port (DP), which is configured to be connected to an expansion device such as a display, and also supports transmission of audio and other forms of data. The HDMI connector can transmit full-digital images and sounds, and can transmit uncompressed audio and video signals. The VGA connector is a traditional analog signal computer display standard, through which a display using the VGA connector can be effectively connected. The audio output connector can output audio signals. The USB connector enables the docking station 10 to be connected to more external expansion devices to expand the functions of the host 30 connected to the docking station 10. The USB connector can provide a signal connection of USB2.0 or above, which may be a type A USB connector, a type B USB connector, or a type C USB connector.

In an embodiment, the external network 36 is a wired network or a wireless network. When the network interface controller 18 is a wired network interface controller, the network interface controller 18 may be connected to the wired network which is the external network 36 through an RJ45 connector to provide a stable and high-bandwidth wired network. In addition, when the network interface controller 18 is a wireless network interface controller, the network interface controller 18 is connected to the wireless network which is the external network 36 to provide a convenient wireless network.

As shown in FIG. 1, since the docking station 10 is to be inserted and removed, that is, when the host 30 is inserted into the first signal I/O port 14, the integrated circuit 12 is configured with and stores a related wake configuration. However, after the host 30 is removed and another host (not shown in the figure) is inserted into the docking station 10, a subsequent wake-on-LAN signal may falsely wake up another host. In order to avoid the false wake-up, the solution may be implemented in combination with an existing insertion detection support of the network interface controller 18 (such as a USB network interface controller). In detail, when the host 30 is inserted into first signal I/O port 14, the integrated circuit 12 is configured with and stores a related wake configuration for use by the host controller 32. However, when the network interface controller 18 detects a disconnection of the host 30, the integrated circuit 12 removes the original wake configuration for subsequent resetting, thereby avoiding false wake-up.

Referring to FIG. 1, if the host controller 32 of the host 30 is first actively woken up before the wake-on-LAN signal is received, the host controller 32 transmits a restore signal to the first controller 20 through the transmission channel 26 (the restore signal sequentially passes through the second controller 34, the first signal I/O Port 14, and the first controller 20). The first controller 20 informs the network interface controller 18 through the function pin 24, so that the network interface controller 18 controls, in response to the restore signal, the integrated circuit 12 to re-establish the signal connection with the first signal I/O port 14. The first controller 20 informs the network interface controller 18 and the network interface controller 18 informs the first controller 20, that both of them transmit signals through the same function pin 24 in the channel.

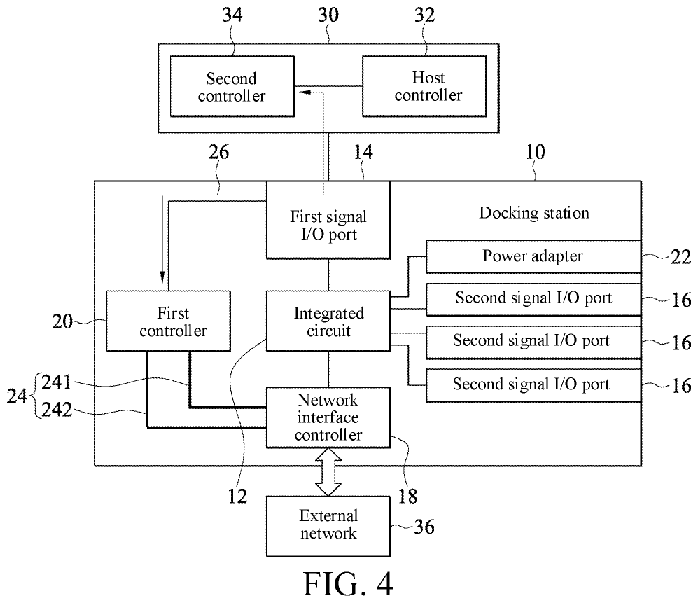

In another embodiment, the first controller 20 may inform the network interface controller 18 and the network interface controller 18 may inform the first controller 20 through different function pins 24 in the channel. Referring to FIG. 4, the function pin 24 further includes a wake pin 241 and a restore pin 242. The network interface controller 18 is electrically connected to the first controller 20 through the wake pin 241. When the network interface controller 18 receives the wake-on-LAN signal from the external network 36, the network interface controller 18 may inform the first controller 20 through the wake pin 241. The first controller 20 is electrically connected to the network interface controller 18 through the restore pin 242. When the host controller 32 is woken up to transmit a restore signal to the first controller 20 through the transmission channel 26, the first controller 20 may inform the network interface controller 18 through the restore pin 242 for signal transmission through respective channels.

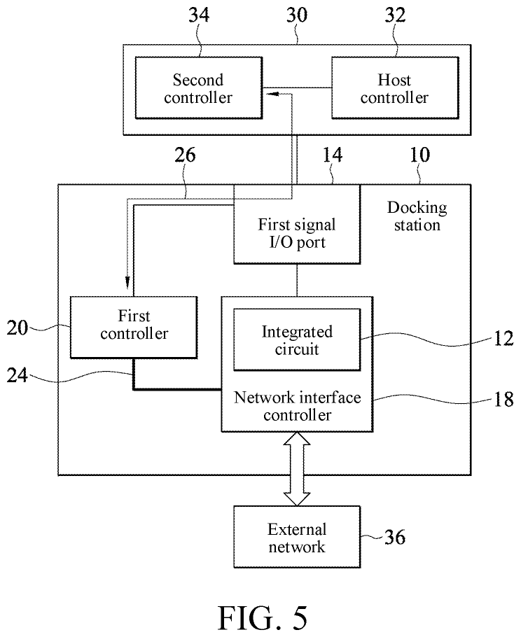

In an embodiment, the integrated circuit 12 may be directly integrated in the network interface controller 18. As shown in FIG. 5, the docking station 10 includes a network interface controller 18, a first signal I/O port 14, and a first controller 20. An integrated circuit 12 is integrated in the network interface controller 18, and the network interface controller 18 has at least one function pin 24. Since the integrated circuit 12 is built in the network interface controller 18, an original electronic circuit in the network interface controller 18 is also electrically connected to the integrated circuit 12. The first signal I/O port 14 is electrically connected to the integrated circuit 12 in the network interface controller 18. The first controller 20 is electrically connected to the function pin 24 and the first signal I/O port 14 to establish a signal connection with the second controller 34 of the host 30 through the first signal I/O port 14 and establish a transmission channel 26 by using the first controller 20, the first signal I/O port 14, and the second controller 34.

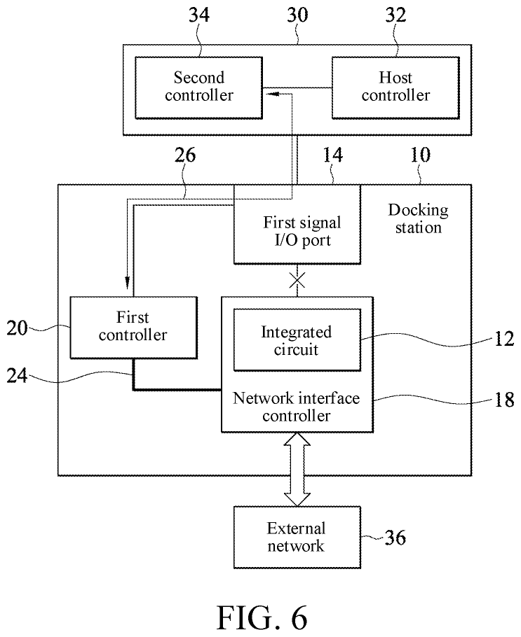

Referring to FIG. 5 and FIG. 6 together, when the host 30 initiates a sleep mode or a standby mode, the network interface controller 18 is disconnected, or there is no network packet transmission, the integrated circuit 12 in the network interface controller 18 cuts off the signal connection between the network interface controller 18 (the integrated circuit 12) and the first signal I/O port 14, so that the host controller 32 enters a deepest sleep state, that is, a D3 cold state. When the network interface controller 18 receives a wake-on-LAN signal from the external network 36, the network interface controller 18 informs the first controller 20 through the function pin 24, and the first controller 20 generates a sideband signal, and transmits the sideband signal to the host controller 32 through the transmission channel 26 to wake up the host controller 32. In addition, the network interface controller 18 controls, in response to the wake-on-LAN signal, the integrated circuit 12 to re-establish the signal connection between the network interface controller 18 (the integrated circuit 12) with the first signal I/O port 14.

Referring to FIG. 5, if the host controller 32 of the host 30 is first actively woken up, the host controller 32 transmits a restore signal to the first controller 20 through the transmission channel 26 (the restore signal sequentially passes through the second controller 34, the first signal I/O Port 14, and the first controller 20). The first controller 20 inform the network interface controller 18 through the function pin 24, so that the network interface controller 18 controls, in response to the restore signal, the integrated circuit 12 to re-establish the signal connection with the first signal I/O port 14.

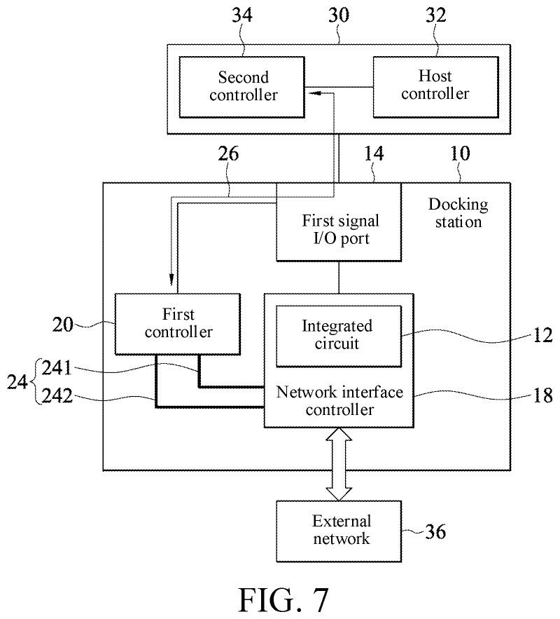

In addition to performing transmission through the same function pin 24 in the channel, the first controller 20 may inform the network interface controller 18 and the network interface controller 18 may inform the first controller 20 through different function pins 24 in the channel. Referring to FIG. 7, the function pin 24 includes a wake pin 241 and a restore pin 242. The network interface controller 18 is electrically connected to the first controller 20 through the wake pin 241. When the network interface controller 18 receives the wake-on-LAN signal from the external network 36, the network interface controller 18 may inform the first controller 20 through the wake pin 241. The first controller 20 is electrically connected to the network interface controller 18 through the restore pin 242. When the host controller 32 is woken up to transmit a restore signal to the first controller 20 through the transmission channel 26, the first controller 20 may inform the network interface controller 18 through the restore pin 242 for signal transmission through respective channels.

Therefore, the docking station provided in the application can effectively manage a power supply, so that the host controller of the host can enter the deepest sleep state (the D3 cold state), and can also support the wake-on-LAN function, thereby minimizing power consumption to achieve maximum power saving.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A docking station for power management adapted to be electrically connected to a host, wherein the host comprises a host controller, and the docking station comprises:
an integrated circuit;
a first signal input/output (I/O) port electrically connected to the integrated circuit and providing a connection to the host controller, so that a signal is transmitted between the host controller and the integrated circuit through the first signal I/O port;
a plurality of second signal I/O ports electrically connected to the integrated circuit;
a network interface controller electrically connected to the integrated circuit, configured to provide a connection to an external network, and having at least one function pin; and
a first controller electrically connected to the function pin and the first signal I/O port, wherein a transmission channel is established between the first controller and the host through the first signal I/O port; wherein
when the host initiates a sleep mode or a standby mode, the network interface controller is disconnected, or there is no network packet transmission, the integrated circuit cuts off a signal connection between the integrated circuit and the first signal I/O port, so that the host controller enters a deepest sleep state, and when the network interface controller receives a wake-on-LAN signal from the external network, the network interface controller informs the first controller through the function pin, the first controller generates a sideband signal, and transmits the sideband signal to the host controller through the transmission channel to wake up the host controller, and the network interface controller controls, in response to the wake-on-LAN signal, the integrated circuit to re-establish the signal connection with the first signal I/O port.

2. The docking station for power management according to claim 1, wherein when the host is inserted into the first signal I/O port, the integrated circuit is configured with and stores a related wake configuration for use by the host controller; and when the network interface controller detects a disconnection of the host, the integrated circuit removes the wake configuration.

3. The docking station for power management according to claim 1, wherein when the host controller is first woken up, the host controller transmits a restore signal to the first controller through the transmission channel, the first controller informs the network interface controller through the function pin, and the network interface controller controls, in response to the restore signal, the integrated circuit to re-establish the signal connection with the first signal I/O port.

4. The docking station for power management according to claim 3, wherein the at least one function pin further comprises a wake pin and a restore pin to enable the network interface controller to inform the first controller through the wake pin, and enable the first controller to inform the network interface controller through the restore pin.

5. The docking station for power management according to claim 3, wherein the first signal I/O port is a USB connector or a thunderbolt connector.

6. The docking station for power management according to claim 5, wherein the host further comprises a second controller electrically connected to the host controller, and the transmission channel is established by using the second controller, the first signal I/O port, and the first controller.

7. The docking station for power management according to claim 6, wherein when the first signal I/O port is the USB connector, the first controller and the second controller each are a power delivery controller.

8. The docking station for power management according to claim 5, wherein the signal connection between the integrated circuit and the first signal I/O port is re-established through USB enumeration.

9. The docking station for power management according to claim 1, wherein the deepest sleep state is a D3 cold state.

10. The docking station for power management according to claim 1, wherein the external network is a wired network or a wireless network.

11. The docking station for power management according to claim 1, further comprising a power adapter electrically connected to the integrated circuit for supplying power.

12. A docking station for power management adapted to be electrically connected to a host, wherein the host comprises a host controller, and the docking station comprises:
a network interface controller configured to provide a connection to an external network, wherein an integrated circuit is integrated within the network interface controller, and the network interface controller has at least one function pin;
a first signal I/O port electrically connected to the integrated circuit and providing a connection to the host controller, so that a signal is transmitted between the host controller and the integrated circuit through the first signal I/O port; and
a first controller electrically connected to the function pin and the first signal I/O port, wherein a transmission channel is established between the first controller and the host through the first signal I/O port; wherein
when the host initiates a sleep mode or a standby mode, the network interface controller is disconnected, or there is no network packet transmission, the integrated circuit cuts off a signal connection between the integrated circuit and the first signal I/O port, so that the host controller enters a deepest sleep state, and when the network interface controller receives a wake-on-LAN signal from the external network, the network interface controller informs the first controller through the function pin, the first controller generates a sideband signal, and transmits the sideband signal to the host controller through the transmission channel to wake up the host controller, and the network interface controller controls, in response to the wake-on-LAN signal, the integrated circuit to re-establish the signal connection with the first signal I/O port.

13. The docking station for power management according to claim 12, wherein when the host is inserted into the first signal I/O port, the integrated circuit is configured with and stores a related wake configuration for use by the host controller; and when the network interface controller detects a disconnection of the host, the integrated circuit removes the wake configuration.

14. The docking station for power management according to claim 12, wherein when the host controller is first woken up, the host controller transmits a restore signal to the first controller through the transmission channel, the first controller informs the network interface controller through the function pin, and the network interface controller controls, in response to the restore signal, the integrated circuit to re-establish the signal connection with the first signal I/O port.

15. The docking station for power management according to claim 14, wherein the at least one function pin further comprises a wake pin and a restore pin to enable the network interface controller to inform the first controller through the wake pin, and enable the first controller to inform the network interface controller through the restore pin.

16. The docking station for power management according to claim 14, wherein the first signal I/O port is a USB connector or a thunderbolt connector.

17. The docking station for power management according to claim 16, wherein the host further comprises a second controller electrically connected to the host controller, and the transmission channel is established by using the second controller, the first signal I/O port, and the first controller.

18. The docking station for power management according to claim 17, wherein when the first signal I/O port is the USB connector, the first controller and the second controller each are a power delivery controller.

19. The docking station for power management according to claim 16, wherein the signal connection between the integrated circuit and the first signal I/O port is re-established through USB enumeration.

20. The docking station for power management according to claim 12, wherein the deepest sleep state is a D3 cold state.
